(19) United States
(12) Patent Application Publication
(10) Pub. No.: US 2018/0202647 A1
(43) Pub. Date: Jul. 19, 2018

(54) INFLATABLE DECORATIVE LIGHTING STRUCTURES

(71) Applicant: Seasons 4, Inc., Toano, VA (US)

(72) Inventor: Jason Loomis, Decatur, GA (US)

(21) Appl. No.: 15/874,777

(22) Filed: Jan. 18, 2018

Related U.S. Application Data
(60) Provisional application No. 62/447,872, filed on Jan. 18, 2017.

(51) Int. Cl. F21V 33/00; A47G 33/06; F21V 21/08

(52) U.S. Cl. CPC F21V 33/0028; F21Y 2115/10; F21V 21/08; A47G 33/06

(57) ABSTRACT

Apparatus and associated methods relate to three-dimensional decorative lighting structures defined by a pliable wire net. The pliable wire net includes an electrical connector configured to receive operating power and includes a plurality of decorative lighting elements that receive operating power from the pliable wire net. The pliable wire net can be compacted to a storage configuration and expanded to an expanded display configuration. The pliable wire net can be expanded to the display configuration by inflating a bladder received into an interior cavity of the pliable wire net. The inflatable bladder is configured to slidably engage the pliable wire net so as to fill the interior cavity during inflation.

### CROSS-REFERENCE TO RELATED APPLICATION(S)

This application claims the benefit of U.S. Provisional Application No. 62/447,872 filed Jan. 18, 2017 for “Inflatable Decorative Lighting Structures” by J. Loomis.

### BACKGROUND

Decorative light strings are used to communicate a joy of a holiday season, to draw attention to merchandise, or to simply decorate or adorn an object. Decorative light strings can be used both indoors and outdoors. Decorative light strings have been used residentially to adorn trees, shrubs, and houses. Commercial businesses can use decorative light strings to provide festive atmospheres at their places of business.

It can be desirable to provide three-dimensional lighting structures. Lighted spheres, trees, or character figures are examples of three-dimensional display objects that can be used as components of a decorative display. But such three-dimensional lighting structures can be bulky for purposes of storage and/or shipping.

Light strings traditionally have been constructed using incandescent bulbs. Light strings that use incandescent bulbs often have been powered using AC line voltages. In more recent times, Light Emitting Diodes (LED) have been used in light strings. LEDs usually require low-voltage DC power for illumination. Therefore, decorative light strings that use LEDs can be powered by low-voltage power levels. Providing a low-voltage power level to a series-connected chain of decorative light strings, however, can result in high current levels.

Such high current levels can cause voltage droop along the series-connected chain, which in turn can cause the LEDs of the last decorative light string to be noticeably dimmer than the LEDs of the first decorative light string. Thus, a method of providing power to long chains of series-connected LED light strings that minimizes the dimming of the last decorative light string of the chain is desired.

### SUMMARY

Apparatus and associated methods relate to an inflatable decorative lighting structure. The inflatable decorative lighting structure includes an inflatable bladder having a substantially smooth exterior surface. The inflatable decorative lighting structure includes a pliable wire net comprising an electrical connector configured to receive operating power from a power source. The pliable wire net has a compact storage configuration and a expanded display configuration. The pliable wire net is configured to receive the inflatable bladder in an interior cavity. The pliable wire net expands to the display configuration in response to inflation of the bladder. The inflatable bladder is configured to slidably engage the pliable wire net so as to fill the interior cavity during inflation. The inflatable decorative lighting structure includes a plurality of lighting elements distributed on the pliable wire net. Each of the plurality of lighting elements is configured to receive operating power from the pliable wire net.

Some embodiments relate to a method of displaying lights in a three-dimensional structure. The method includes providing a pliable wire net having a compact storage configuration and a expanded display configuration. The method includes distributing a plurality of lighting elements on the pliable wire net. The method includes inserting an inflatable bladder into a cavity in the pliable wire net, wherein the inflatable bladder has a substantially smooth exterior surface. The method includes inflating the bladder thereby expanding the pliable wire net to the expanded display configuration. The inflatable bladder is configured to slidably engage the pliable wire net so as to substantially fill the interior cavity during inflation. The method includes providing operating power from a power source to the pliable wire net. The method also includes distributing the received operating power from the pliable wire net to the plurality of lighting elements.

### BRIEF DESCRIPTION OF THE DRAWINGS

FIG. 1 is a perspective view of an exemplary three-dimensional lighting structure inflated to form via an interior bladder.

FIG. 2 is a perspective view of an exemplary three-dimensional lighting structure deflated for storage or transportation.

FIG. 3 is a schematic view of a home decorated with a long chain of series-connected decorative light strings.

FIG. 4 is a schematic diagram of an exemplary long-chain-tolerant decorative LED light string.

FIG. 5 is a circuit schematic diagram of an exemplary lighting element of a long-chain-tolerant decorative LED light string.

FIG. 6 is a circuit schematic of an exemplary power supply for a long chain of decorative LED light strings.

### DETAILED DESCRIPTION

Apparatus and associated methods relate to three-dimensional decorative lighting structures defined by a pliable wire net. The pliable wire net includes an electrical connector configured to receive operating power and includes a plurality of decorative lighting elements that receive operating power from the pliable wire net. The pliable wire net can be compacted to a storage configuration and expanded to a expanded display configuration. The pliable wire net can be expanded to the display configuration by inflating a bladder received into an interior cavity of the pliable wire net. The inflatable bladder is configured to slidably engage the pliable wire net so as to fill the interior cavity during inflation.

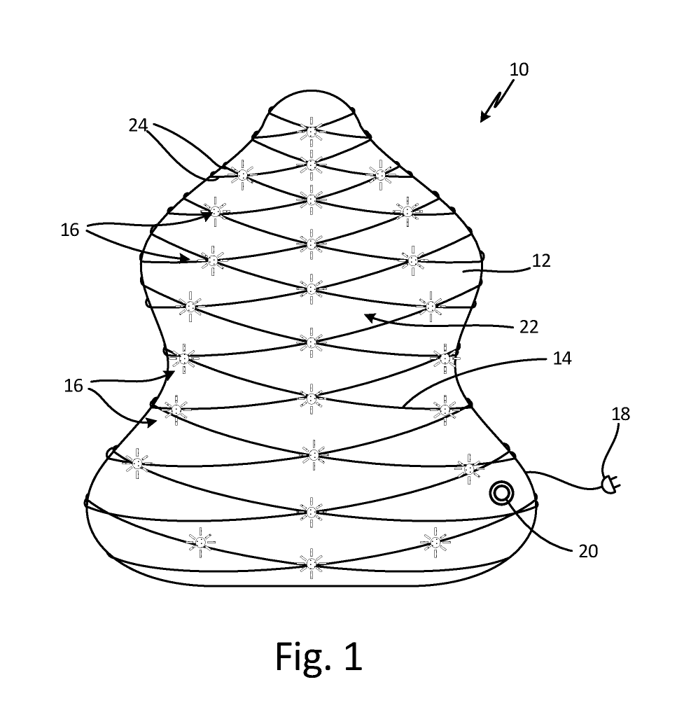

FIG. 1 is a perspective view of an exemplary three-dimensional lighting structure inflated to form via an interior bladder. In FIG. 1, inflatable decorative lighting structure 10 includes inflatable bladder 12, pliable wire net 14, plurality of lighting elements 16, and electrical connector 18. In the depicted embodiment, inflatable decorative lighting structure 10 has the topography of a small evergreen tree. Inflatable bladder 12 has inflation port 20. Inflation port 20 has an open position so as to receive air or other gas when bladder 12 is being inflated and a closed position to seal bladder 12 so that the air or other gas remains within inflatable bladder 20. Inflatable bladder 12 can be opaque, translucent, and/or transparent. Transparent bladders can facilitate visualization of lights all about inflatable decorative lighting structure 10 for every vantage point.

Electrical connector 18 is configured to receive power from a power source. In some embodiments, electrical connector 18 is configured to receive standard line power. In some embodiments, electrical connector 18 is configured to receive power generated by a power transformer. In some embodiments, electrical connector is further configured to receive illumination data from a display controller. Pliable wire net 14 has electrical conductors configured to provide operating power to the plurality of lighting elements 16 distributed on pliable wire net 14. In some embodiments, pliable wire net 14 has electrical conductors configured to distribute illumination data to at least one of lighting elements 16. In some embodiments, pliable wire net 14 has electrical conductors configured to distribute illumination data to each of the plurality of lighting elements 16. Because most metals used for electrical conduction have a tensile strength sufficient to contain the expansion of an elastic bladder, the expanded display form of pliable wire net 14 can be predetermined by configuration of pliable wire net 14. Exemplary pliable wire nets, such as pliable wire net 14, resists expansion beyond an internal cavity volume of predetermined threshold, based on net configuration.

Inflatable bladder 12, when deflated, can be inserted into and/or removed from the internal cavity of pliable wire net 14, via any one of windows 22 between wires 24 of pliable wire net 14. In some embodiments, inflatable bladder 12 is substantially elastic so as to take the form of pliable wire mesh 14 when fully expanded to an expanded volume. A pressure of gas internal to bladder 12 need not be very high to fully inflate pliable wire net 14 to the expanded display configuration. In some embodiments, pressures of about one atmosphere or less are typically sufficient to fully inflate pliable wire net 14, for example. In some embodiments, inflatable bladder 12 is substantially inelastic. In such embodiments, inflatable bladder 12 is formed substantially commensurate with the internal cavity of pliable wire net 14 when in the expanded display configuration.

During the inflation operation, a registration between inflatable bladder 12 and pliable wire net 14 may not be precise. In such scenarios, inflatable bladder 14 can be repositioned within the internal cavity of pliable wire net 14 during the inflation operation. Inflatable bladder 12 has a substantially smooth exterior surface to facilitate such repositioning. In some embodiments, an interior surface of the internal cavity within pliable wire net 14 is configured to facilitate sliding of inflatable bladder 12 within the internal cavity. Materials for both the exterior surface of inflatable bladder 12 and the interior surface of the internal cavity within pliable wire net 14 can be chosen to provide a coefficient of friction therebetween, static and/or dynamic, that is less than a predetermined threshold. For example, in some embodiments the coefficient of friction is less than about 0.3, 0.25, 0.18 or less than about 0.15, for example.

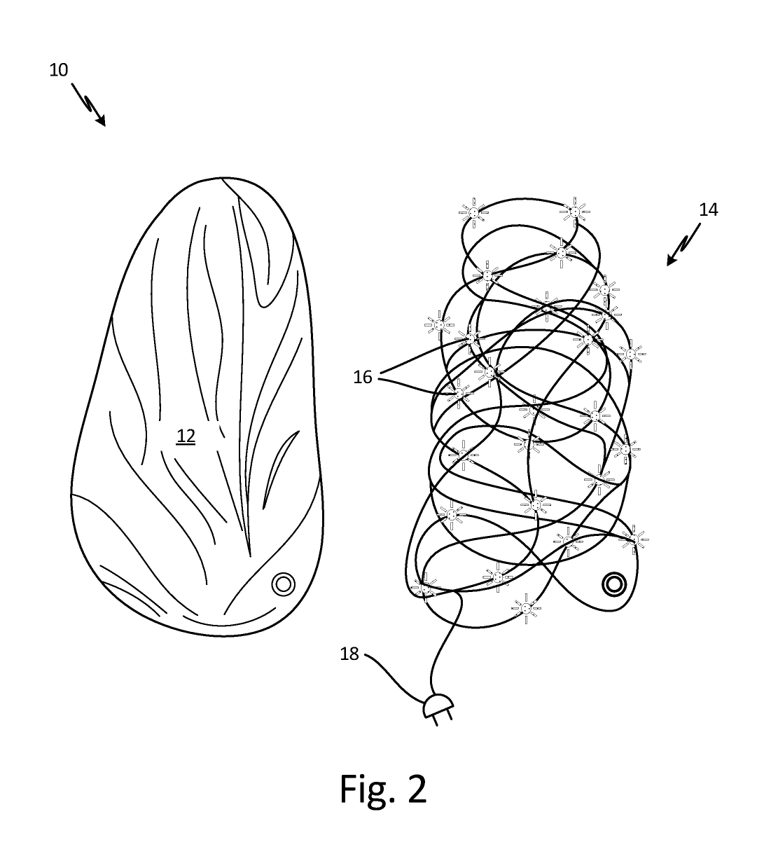

FIG. 2 is a perspective view of exemplary three-dimensional lighting structure deflated for storage or transportation. In FIG. 2 inflatable decorative lighting structure 10 includes inflatable bladder 12, pliable wire net 14, plurality of lighting elements 16, and electrical connector 18. Inflatable bladder 12 is shown removed from pliable wire net 14. Inflatable bladder 12 is shown in a deflated configuration, and rolled and/or folded into a small volume. Pliable wire net 14 is shown in a compact storage mode. A combined volume of inflatable bladder 12 and pliable wire net 14 in storage and/or transportation mode can be many times smaller the combined volume in the display mode. For example, in some embodiments a ratio between the volumes of display mode to storage mode can be greater than about 50, 100, or greater than about 150, for example.

In some embodiments, inflatable decorative lighting structure 10 can have a second connector for providing power and/or illumination data to other lighting displays connected thereto. In some embodiments, the second connector is located on an opposite side of inflatable decorative lighting structure 10 when in the inflated display mode. In some embodiments, a second connector can be located to provide operating power and/or illumination control to a lighting display that is configured to be complementary to inflatable decorative lighting structure 10 (e.g., a star atop a Christmas tree).

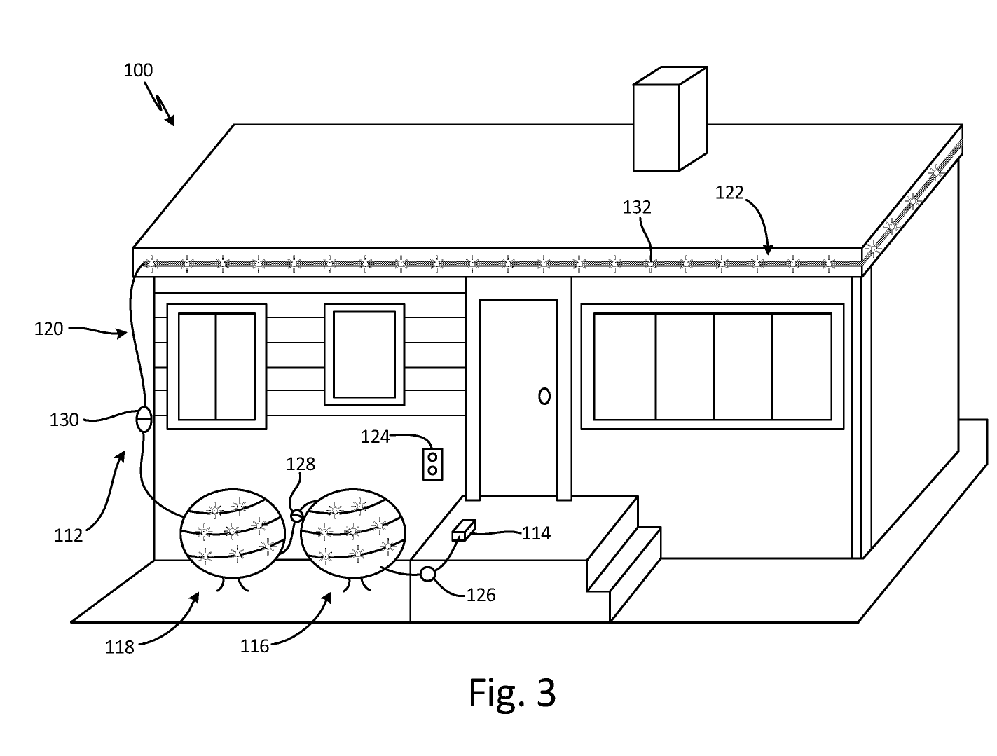

FIG. 3 is a schematic view of a home decorated with long chain of series-connected decorative light strings. In FIG. 3, home 110 is decorated with lighting system 112 for a holiday season. Lighting system 112 includes a power supply 114 and decorative LED light strings 116, 118, 120 and 122. Power supply 114 is plugged into house outlet 124 and draws operating current from standard AC line voltage (e.g., 120 VAC). Decorative light strings 116, 118, 120 and 122 are series connected. First decorative LED light string 116 is connected to power supply 114 via connector pair 126. Second decorative LED light string 118 is connected to first decorative LED light string 116 via connector pair 128. Third decorative LED light string 120 is connected to second decorative LED light string 118 via connector pair 130. Fourth decorative LED light string 122 is connected to third decorative LED light string 120 via connector pair 132. Each of connector pairs 126, 128, 130 and 132 includes a connector coupled to a first of the connected elements (e.g., a connector of power supply 114), and a complementary connector coupled to a second of the connected elements (e.g., a connector of first decorative light string 116).

Operating power for decorative LED light strings 116, 118, 120 and 122 is provided by power supply 114. In some embodiments, power supply 114 converts power from standard AC line voltage to a form compatible with LED light strings 116, 118, 120 and 122. For example, in an exemplary embodiment, power supply 114 converts 1120 VAC power to high-voltage DC power. In other embodiments, however, decorative light strings 116, 118, 120 and 122 can be made to be compatible with 120 VAC. In such embodiments, power supply 114 can be omitted, and first decorative LED light string 116 can be directly plugged into house outlet 124. Regardless of the specific power configuration, the chain of series-connected decorative LED light strings 116, 118, 120 and 122 is supplied operating power, both voltage and current, through the connector of connector pair 126 that is coupled to first decorative LED light string 116.

All operating current for decorative LED light strings 116, 118, 120 and 122 will be conducted through connector pair 126 in lighting system 112 as depicted in FIG. 3. Connector pair 128 will conduct operating current for decorative LED light strings 118, 120 and 122. Connector pair 130 will conduct operating current for decorative LED light strings 120 and 122. Connector pair 132 will conduct operating current only for decorative LED light strings 122. Operating power for decorative LED light strings 116, 118, 120 and 122 is calculated as the product of the operating voltage and the operating current. Thus, a specific operating power can be achieved using different voltages and currents. For example, a first power configuration may use high operating current and low operating voltage to achieve a specific operating power, while a second power configuration may use a lower operating current a higher operating voltage.

Although both the first and second power configurations achieve the same operating power, the current differences can have secondary consequence. Because the operating current for light strings 116, 118, 120 and 122 is conducted through connector pair 126, a voltage drop will occur across connector pair 126, as connector pair 126 has a non-zero parasitic resistance associated with connector pair 126. Furthermore, a voltage drop will occur across both decorative LED light sting 116 and connector pair 128 due to parasitic resistances, as a result of conduction therethrough of operating current for lights strings 118, 120 and 122. The first power configuration, which achieves the specific operating power using high operating currents will have larger voltage drops across lighting elements 126, 116, 128, etc. than will the second power configuration which achieves the same specific operating power but uses lower operating currents. Use of high-voltage/low-current power configurations can permit the use of long chains of series-connected decorative LED light strings.

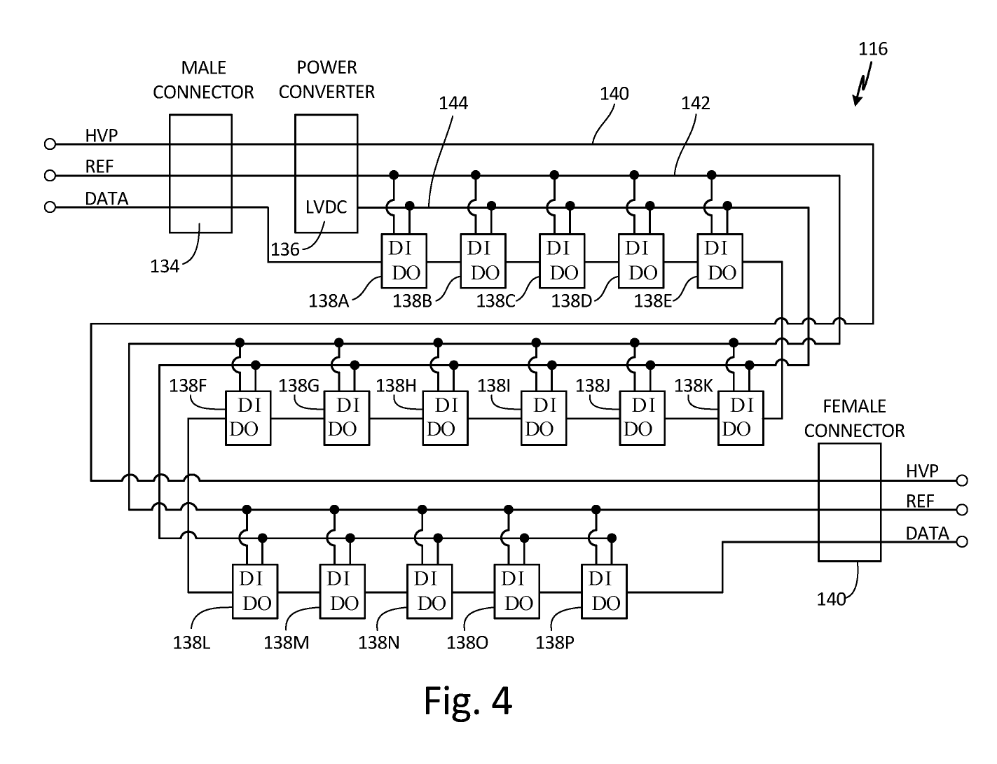

FIG. 4 is a schematic diagram of an exemplary long-chain-tolerant decorative LED light string. In FIG. 4, decorative LED light string 116 of FIG. 3 is shown in schematic form. Decorative LED light string 116 includes first connector 134, power converter 136, lighting elements 138A-138P, and second connector 140. First connector 134 is labeled as MALE CONNECTOR, and second connector 140 is labeled as FEMALE CONNECTOR in the depicted embodiment. Various embodiments can have various configurations of connectors. To facilitate series connectivity of multiple decorative LED light stings, however, first connector 134 and second connector 140 are complementary connectors. Connectors are complementary when they mate or engage with one another. Thus, first connector 134 of a subsequent and decorative LED light string (and perhaps identical to decorative LED light string 116, e.g., decorative light string 118 depicted in FIG. 3) can mate or engage with second connector 140 of decorative LED light string 116 depicted in FIGS. 3 and 4, if first connector 134 and second connector 140 are complementary to one another.

In the depicted embodiment, each of connectors 134 and 140 has three contacts. First connector 134 has contacts labeled: i) high-voltage power HVP; ii) power reference REF; and iii) and data-in DATA. Second connector 140 has contacts labeled: i) high-voltage power HVP; ii) power reference REF; and iii) data-out DATA. Contacts HVP and REF of first connector 134 receive operating power for decorative LED light string 116. Conductors 140 and 142 provide electrical conduction of the received operating power to both power converter 136 and second connector 140. Second connector 140 thereby provides operating power to one or more additional decorative LED light string attached thereto.

Power converter 136 converts the received high-voltage power to a low-voltage DC power suitable for consumption by lighting elements 138A-138P. In some embodiments, the received high-voltage power is 120 VAC line power. In such embodiments, power converter 136 converts the received 120 VAC line power to the low-voltage DC power suitable for consumption by lighting elements 138A-138P. In some embodiments, the received high-voltage power is a high-voltage DC power. For example, in an exemplary embodiment, power supply 114 (depicted in FIG. 3) converts 120 VAC line power to high-voltage DC power by rectifying and filtering the 120 VAC line power. In such embodiments, power converter 136 converts the received high-voltage DC power to the low-voltage DC power suitable for consumption by lighting elements 138A-138P. In still other embodiments, power converter 136 is configured to convert power from other high-voltage power specifications to the low-voltage DC power suitable for consumption by lighting elements 138A-138P.

In the depicted embodiment, power converter 136 provides the low-voltage DC power suitable for consumption by lighting elements 138A-138P on conductor 144. In the depicted embodiment, the converted low-voltage DC power provided to conductor 144 is referenced to power reference REF of conductor 142. Conductors 142 and 144 provide the converted low-voltage DC power to each of lighting elements 138A-138P. In some embodiments, the converted low-voltage DC power will have an isolated reference, independent of power reference REF of conductor 142. In such embodiments, an additional conductor will provide the isolated reference voltage to lighting elements 138A-138P. In such embodiments, the additional conductor along with conductor 144 can provide the converted low-voltage DC power to each of lighting elements 138A-138P.

Lighting elements 138A-138P are identical to one another in the depicted embodiment. Lighting elements 138A-138P are wired in daisy chain fashion from the data-in contact of first connector 134 to the data-out contact of second conductor 140 via data-in DI and data-out DO ports of lighting elements 138A-138P. First connector 134 receives illumination control data on the data-in contact of first connector 134. The received illumination control data can independently control the illumination of each of lighting elements 138A-138P, as well as independently controlling lighting elements of one or more decorative LED light strings attached to second connector 140. The received illumination control data may include brightness control, color control, and/or temporal control (e.g., flashing or other temporal lighting variations).

Each of daisy-chained lighting elements 138A-138P receives the illumination control data at data-in port DI. Each of daisy-chained lighting elements 138A-138P then processes the received illumination control data and controls the illumination based on the received illumination control data. The received illumination control data includes data corresponding to the lighting element that receives the data as well as data corresponding to lighting elements downstream the daisy chain of lighting elements from the lighting element that receives the data. Thus, each of the daisy-chained lighting elements 138A-138P transmits at least some of the received illumination data to downstream lighting elements via the data-out port DO of the lighting element.

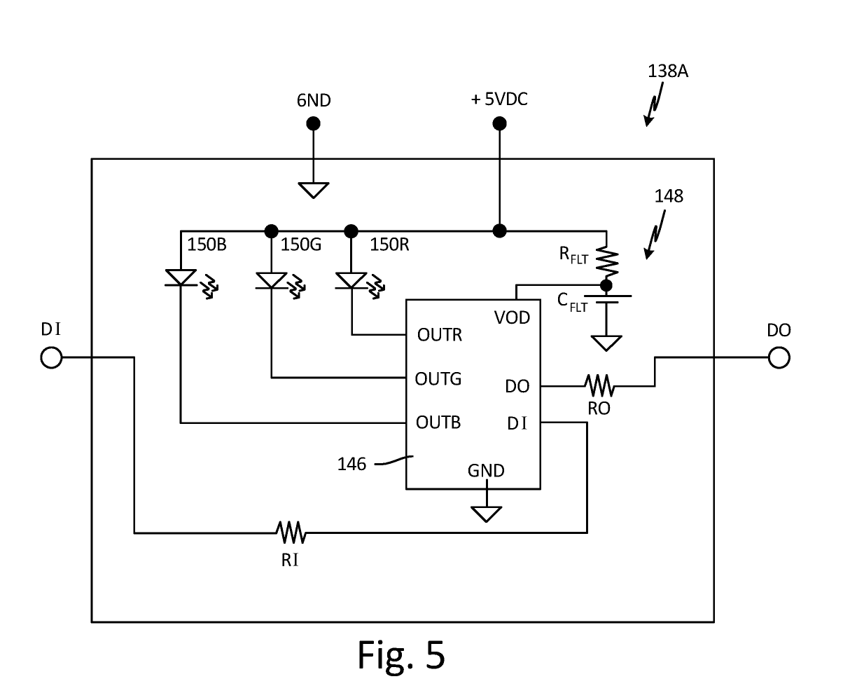

FIG. 5 is a circuit schematic diagram of an exemplary lighting element of a long-chain-tolerant decorative LED light string. In FIG. 5, lighting element 138A of FIG. 4 is shown in schematic form. Lighting element 138A includes data-in port DI, data-out port DO, ground port GND, low-voltage DC, and power port +5 VDC. Lighting element 138A also includes illumination controller 146, resistors RI and RO, power filter 148, and LEDs 150R, 150G and 150B. In the depicted embodiment, power filter 140 includes resistor R_{FLT} and capacitor C_{FLT}. In various embodiments, various power filters can be used. For example, in some embodiments, an inductor can be used in addition to or replacing resistor R_{FLT}. In some embodiments, no power filter is used.

Illumination controller 146 has pins: i) power VDD; ii) ground GND; iii) data-in DI; iv) data-out DO; v) red LED control OUTR; vi) green LED control OUTG; and vii) blue LED control OUTB. LEDs 150R, 150G and 150B each have cathodes that are electrically connected both to one another and to the low-voltage DC power (e.g., +5 V in the depicted embodiment). Illumination controller 146 controls currents flowing through each of LEDs 150R, 150G and 150B via control pins OUTR, OUTG and OUTB, respectively. Illumination controller 146 controls the currents flowing through LEDs 150R, 150G and 150B based on the illumination control data received on the data-in port DI of lighting element 138A and electrically conducted to the data-in pin DI of illumination controller 146.

In various embodiments, illumination controller 146 controls the illumination color, brightness, and temporal pattern of illumination. For example, illumination controller 146 can control color by controlling the relative intensities of the red, green and blue light illuminated by LEDs 150R, 150G and 150B, respectively. Illumination controller 146 can control brightness by controlling the absolute intensity of the combination of red, green and blue light illuminated by LEDs 150R, 150G and 150B, respectively. Illumination controller 146 can control the temporal pattern of illumination by temporally changing these relative and absolute intensities as a function of time.

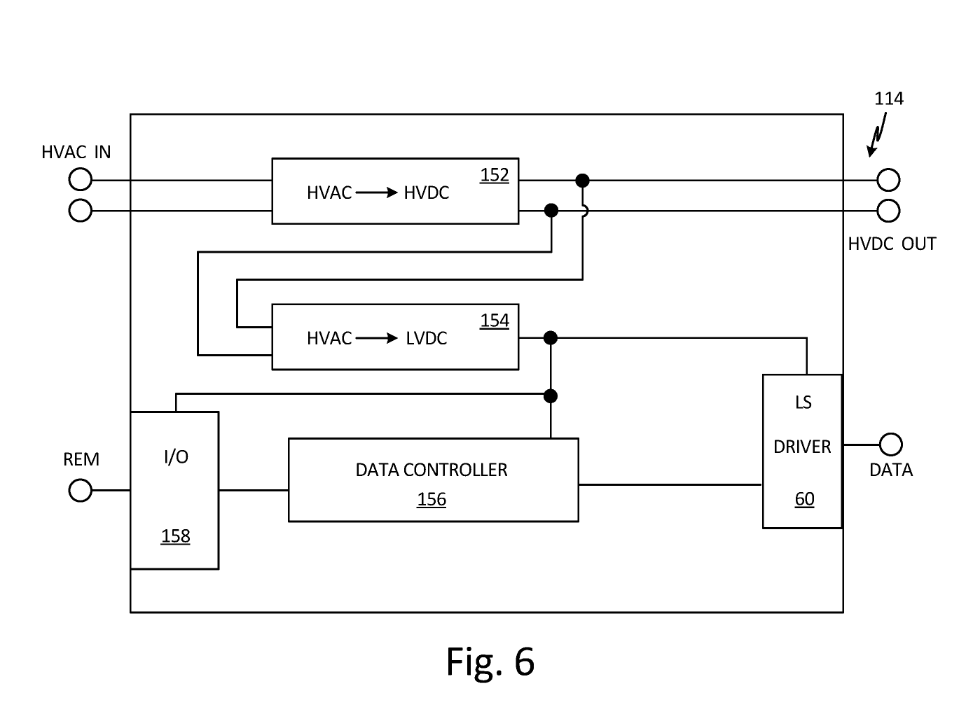

FIG. 6 is a block schematic of an exemplary power supply for a long chain of decorative LED light strings. In FIG. 6, exemplary power supply 114 depicted in FIG. 3 is shown in block diagram form. Power supply 114 includes high-voltage AC/high-voltage DC converter, 152, high-voltage DC/low-voltage DC converter 154, data controller 156, input/output interface 158 and light-string driver 60. Power supply 114 also has high-voltage AC input port HVAC_IN, high-voltage DC output port HVDC_OUT, remote data input port REM, and light-string data output port DATA.

High-voltage AC/high-voltage DC converter 152 receives high-voltage AC power from high-voltage AC input port HVAC_IN. High-voltage AC/high-voltage DC converter 152 converts the received high-voltage AC power to high-voltage DC power and provides the converted high-voltage DC power to a connected chain of light strings via high-voltage DC output port HVDC_OUT, and provides the converted high-voltage DC power to high-voltage DC/low-voltage DC converter 154. High-voltage DC/low-voltage DC converter 154 converts the received high-voltage DC power to low-voltage DC power and provides the converted low-voltage DC power to each of data controller 156, input/output interface 158 and light-string driver 60.

Data controller 156 generates an illumination control signal and provides it to the connected chain of light strings via light-string data output port DATA. Data controller may store data corresponding to various illumination patterns, and/or may receive various illumination patterns from a remote pattern generator via input/output interface 158.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An inflatable decorative lighting structure comprising:
an inflatable bladder;
a pliable wire net comprising an electrical connector configured to receive operating power from a power source, the pliable wire net having a compact storage configuration and an expanded display configuration, the pliable wire net configured to receive the inflatable bladder in an interior cavity, the pliable wire net expanding to the display configuration in response to inflation of the bladder, wherein the inflatable bladder is configured to slidably engage the pliable wire net so as to fill the interior cavity during inflation; and
a plurality of lighting elements distributed on the pliable wire net, each of the plurality of lighting elements configured to receive operating power via the pliable wire net.

2. The inflatable decorative lighting structure of claim 1, wherein the inflatable bladder has, when inflated, a topography that is commensurate with the expanded display configuration of the pliable wire net.

3. The inflatable decorative lighting structure of claim 1, wherein the inflatable bladder is configured to elastically expand to fill the internal cavity of the pliable wire net.

4. The inflatable decorative lighting structure of claim 1, wherein the inflatable bladder has a substantially smooth exterior surface resulting in a static coefficient of friction between the substantially smooth exterior surface of the inflatable bladder and an interior surface of the cavity of the pliable wire net is less than a predetermined threshold.

5. The inflatable decorative lighting structure of claim 1, wherein a dynamic coefficient of friction between the substantially smooth exterior surface of the inflatable bladder and an interior surface of the cavity of the pliable wire net is less than a predetermined threshold.

6. The inflatable decorative lighting structure of claim 1, wherein the electrical connector is further configured to receive illumination data from an illumination controller.

7. The inflatable decorative lighting structure of claim 6, wherein each of the plurality of lighting elements has a controller configured to receive illumination data from the pliable wire net, and configured to control illumination of the lighting element.

8. The decorative light string of claim 7, wherein each of the plurality of lighting elements includes a red LED, a green LED, and a blue LED.

9. The decorative light string of claim 8, wherein the controller of each of the plurality of lighting elements is configured to control, in response to the received illumination data, brightness of each of the red, green, and blue LEDs of the lighting element.

10. The decorative light string of claim 7, wherein the controller of each of the plurality of lighting elements is configured to control, in response to the received illumination data, a temporal behavior of each of the red, green and blue LEDS of the lighting element.

11. A method of displaying lights in a three-dimensional structure, the method comprising:
providing a pliable wire net having a compact storage configuration and a expanded display configuration;
distributing a plurality of lighting elements on the pliable wire net;
inserting an inflatable bladder into a cavity in the pliable wire net;
inflating the bladder to thereby expand the pliable wire net to the expanded display configuration, wherein the inflatable bladder is configured to slidably engage the pliable wire net so as to substantially fill the interior cavity during inflation;
providing operating power from a power source to the pliable wire net; and
distributing the received operating power from the pliable wire net to the plurality of lighting elements.

12. The method of claim 11, wherein the inflatable bladder has, when inflated, a topography that is commensurate with the expanded display configuration of the pliable wire net.

13. The method of claim 11, wherein the inflatable bladder is configured to elastically expand to fill the internal cavity of the pliable wire net.

14. The method of claim 11, wherein the inflatable bladder has a substantially smooth exterior surface, the method further comprising providing an interior surface of the cavity of the pliable wire net that engages the smooth exterior surface of the inflatable bladder with a static coefficient of friction less than a predetermined threshold.

15. The method of claim 11, wherein the inflatable bladder has a substantially smooth exterior surface, the method further comprising providing an interior surface of the cavity of the pliable wire net that engages the smooth exterior surface of the inflatable bladder with a dynamic coefficient of friction less than a predetermined threshold.

16. The method of claim 11, further comprising providing illumination data to the pliable wire net.

17. The method of claim 16, further comprising distributing the illumination data to the plurality of lighting elements.

18. The method of claim 11, wherein each of the plurality of lighting elements includes a red LED, a green LED, and a blue LED.

19. The method of claim 18, further comprising controlling brightness of each of the red, green, and blue LEDs of the lighting element.

20. The method of claim 18, further comprising controlling temporal behavior of each of the red, green and blue LEDS of the lighting element.
